(19) United States
(12) Patent Application Publication
(10) Pub. No.: US 2017/0277538 A1
(43) Pub. Date: Sep. 28, 2017

(54) SPECULATIVE MULTI-THREADING TRACE PREDICTION

(71) Applicant: Centipede Semi Ltd., Natania (IL)

(72) Inventors: Jonathan FRIEDMANN, Even-Yehuda (IL); Noam MIZRAHI, Hod-HaSharon (IL); Arie Hacohen BEN-PORAT, Tel-Aviv (IL); Ido GOREN, Herzlia (IL); Alberto MANDLER, Zikhron-Yaakov (IL); Shay KOREN, Tel-Aviv (IL)

(21) Appl. No.: 15/079,181

(22) Filed: Mar. 24, 2016

(51) Int. Cl. G06F 9/30; G06F 9/38; G06F 12/08

(52) U.S. Cl. CPC G06F 9/30058; G06F 12/0875; G06F 9/3867; G06F 2212/452

(57) ABSTRACT

A method for trace prediction includes using trace prediction to predict a trace specifying branch decisions. When a branch misprediction is detected, trace prediction is terminated and prediction is continued using branch prediction.

### FIELD AND BACKGROUND OF THE INVENTION

The present invention, in some embodiments thereof, relates to parallel processing of code instructions and, more particularly, but not exclusively, to trace prediction during parallel processing.

Many techniques have been developed to increase the efficiency and speed at which concurrent instructions may be processed using instruction level parallel processing. Among these techniques are branch prediction, trace prediction and the trace cache.

Branch predictors attempt to predict whether branches in the code instructions will or will not be taken, before the branch is executed. When the branch is predicted correctly, the correct instruction is fetched prior to executing the branch and parallel processing continues correctly. However if the branch is predicted incorrectly, the wrong instruction is fetched. Subsequent operations will have to be flushed once the misprediction becomes known.

The trace cache and trace prediction use traces as the basic blocks for expediting parallel processing. Traces are sequences of code instructions which incorporate within them a sequence of branch decisions. Different decisions at branch points in the code will follow a different sequence of code instructions.

E. Rotenberg, S. Bennett and J. Smith, describe a trace cache in “Trace Cache: a Low Latency Approach to High Bandwidth Instruction Fetching,” in Proceedings of the 29^{th} Annual International Symposium on Microarchitecture, Dec. 2-4, 1996. The trace cache stores the sequence of instructions forming the trace. When the trace is encountered, there is no need to fetch instructions from non-continuous places in the cache due to taken branches (which typically causes a delay in the fetch time) since the entire sequence of instructions is already available in the trace cache.

Q. Jacobson, E. Rotenberg and J. Smith describe a trace prediction in, “Path-Based Next Trace Prediction,” in Proceedings of Micro-30, Dec. 1-3, 1997, which is incorporated herein in by reference in its entirety. The trace predictor collects histories of previous trace sequences and predicts subsequent traces based on these histories.

Additional background art includes:
[1] E. Rotenberg, Q. Jacobson, Y. Sazeides and J. Smith, “Trace Processors,” in Proceedings of Micro-30, Dec. 1-3, 1997.
[2] Q. Jacobson, S. Bennett, N. Sharma and J. Smith, “Control Flow Speculation in Multiscalar Processors,” in Proceedings of the Third International Symposium on High Performance Computer Architecture, Feb. 1-5, 1997.

### SUMMARY OF THE INVENTION

Embodiments described herein use both trace prediction and branch prediction to generate predictions which are used to process code instructions according to a predicted sequence. Typically, the predictions are made by trace prediction. However when a misprediction is detected for a branch within the trace, trace prediction is suspended and subsequent predictions are made by branch prediction. In some embodiments, branch prediction is used when there are no traces associated with this point in the code.

According to an aspect of some embodiments of the present invention there is provided a method performed in a processor that executes instructions of program code, the method including:

using trace prediction to predict a trace specifying branch decisions, wherein each trace is associated with an invocation instruction identifier (IID) identifying a code instruction beginning the trace;

detecting a branch misprediction during processing of the predicted trace; and

in response to detecting a branch misprediction within a trace, terminating the trace prediction and continuing subsequent predictions using branch prediction.

According to some embodiments of the invention, the method further includes processing the predicted trace by:

for each taken branch in the trace, accessing a branch target buffer (BTB) to obtain a respective target address of a current branch; and

accessing an instruction cache with the target address to retrieve a code instruction.

According to some embodiments of the invention, the method further includes resuming trace prediction to determine a continuing sequence of traces when an IID is reached during branch prediction.

According to some embodiments of the invention, the method further includes terminating the trace prediction and continuing subsequent predictions using branch prediction, in response to detecting that a final code instruction at which a previous trace ends is unassociated with any traces.

According to some embodiments of the invention, using trace prediction includes retrieving a predicted trace from a prediction table indexed by a function of a trace history.

According to some embodiments of the invention, the trace history consists of a plurality of previously-predicted traces and executed traces.

According to some embodiments of the invention, the trace history includes at least one previously-constructed trace and at least one branch predicted by branch prediction.

According to some embodiments of the invention, the trace prediction table further includes respective confidence levels for traces stored in the trace prediction table.

According to some embodiments of the invention, the method further includes updating a respective confidence level for the executed trace when a trace is executed.

According to some embodiments of the invention, the method further includes updating a respective confidence level for the trace when a branch from the trace is executed and found to be mispredicted.

According to some embodiments of the invention, the method further includes updating a trace history when a branch is predicted and a trace is formed.

According to some embodiments of the invention, the method further includes: when a trace is committed, updating a respective confidence level for the committed trace.

According to some embodiments of the invention, the method further includes: when a branch from the predicted trace is executed, updating at least one of a branch history and data used for the branch prediction.

According to some embodiments of the invention, updating data used for branch prediction includes: transforming a trace history representation, up to the executed branch, into a branch history representation, and using a function of the branch history for index generation to a branch predictor table.

According to some embodiments of the invention, branch prediction includes transforming a trace history, up to a mispredicted branch, into a branch history, and using a function of the branch history for index generation to a branch predictor table in order to produce branch predictions.

According to some embodiments of the invention, using trace prediction includes:

maintaining a trace database storing, for combinations of an IID and a trace name, a respective sequence of branch predictions;

inputting an IID and trace name of a predicted trace; and

retrieving from the trace database, using the input IID and trace name, the respective sequence of branch predictions.

According to some embodiments of the invention, the trace database further stores, for combinations of an IID and a trace name, a respective next IID reached after processing the sequence of branch predictions, and the method further includes: retrieving from the trace database, using the input IID and trace name, a next IID reached after processing the sequence of branch decisions.

According to some embodiments of the invention, the method further includes selecting a different type of prediction to continue the predicting, when the sequence of branch predictions is unretrievable from the trace database.

According to some embodiments of the invention, the method further includes generating a new trace from at least one of executed branches and branches predicted by branch prediction, and entering the new trace into the trace database.

According to some embodiments of the invention, the new trace enters a trace history used for the trace prediction.

According to some embodiments of the invention, when the trace database stores a single trace for an IID, a trace is predicted based on history data of the IID.

According to some embodiments of the invention, the method further includes predicting a trace based on history data for a single IID. According to some embodiments of the invention, the predicted trace is one of an immediately preceding predicted trace and a most frequently predicted trace of the single IID.

According to some embodiments of the invention, using trace prediction to predict a trace includes:

using multiple types of trace prediction to obtain respective predicted traces; and

selecting one of the predicted traces in accordance with specified logic.

According to some embodiments of the invention, the method further includes generating a plurality of trace predictions for respective hardware threads.

According to some embodiments of the invention, the method further includes outputting a trace prediction to a first-in first-out (FIFO) buffer each processor cycle and using the predictions in the FIFO as resources become available.

According to an aspect of some embodiments of the present invention there is provided a predictor for parallelized processing of code instructions. The predictor includes a processor which executes code instructions for:

during pipeline processing of code instructions, using trace prediction to predict a trace specifying a plurality of branch decisions, wherein each trace is associated with an invocation instruction identifier (IID) identifying a code instruction beginning the trace;

detecting a branch misprediction within the predicted trace; and

in response to the detecting, terminating the trace prediction and continuing subsequent predictions using branch prediction.

According to some embodiments of the invention, the processor executes further code to process the predicted trace by:

for each taken branch in the trace, accessing a branch target buffer (BTB) to obtain a respective target address of a current branch; and

accessing an instruction cache with the target address to retrieve a code instruction.

According to some embodiments of the invention, the processor executes further code to resume trace prediction when a trace IID is reached during the pipeline processing.

According to some embodiments of the invention, the predictor further includes at least one non-transient memory storing a trace database maintaining, for combinations of an invocation instruction identifier (IID) and a trace name, a respective sequence of branch decisions.

According to some embodiments of the invention, using trace prediction includes:

predicting a plurality of traces, each of the predictions being based on a respective trace history;

selecting one of the plurality of predicted traces.

According to some embodiments of the invention, when a trace predicted based on a trace history which includes multiple previously-predicted traces is invalid, the trace prediction is performed based on history data of a single IID.

According to an aspect of some embodiments of the present invention there is provided a method performed in a processor that executes instructions of program code, the method including:

monitoring sequences of instructions processed in the program code;

defining traces within the processed sequences of code, each trace being specified by a respective invocation instruction identifier (IID) identifying a code instruction beginning the trace and a sequence of branch decisions;

for each of the traces, assigning a trace name to the respective sequence of branch decisions and storing the trace names in a prediction table;

obtaining an index into the prediction table by applying a function to a specified history of traces; and

retrieving a trace name from the prediction table using the index.

According to some embodiments of the invention, the method further includes:

maintaining a trace database storing, for combinations of an IID and a trace name, a respective sequence of branch decisions; and

retrieving from the trace database, based on the retrieved trace name and a specific IID, the respective sequence of branch decisions.

According to some embodiments of the invention, the history of traces includes a history of names of traces.

According to some embodiments of the invention, the method further includes, for an IID, assigning a new set of branch decisions to a trace name and updating the trace database with the new set of branch decisions.

According to some embodiments of the invention, the trace database further stores, for combinations of an IID and a trace name, a respective next IID reached after processing the sequence of branch predictions, and the method further includes retrieving from the trace database, using the IID and trace name, a next IID reached after processing the sequence of branch decisions.

According to some embodiments of the invention, the method further includes detecting an invalid trace when a sequence of branch predictions is unretrievable from the trace database for the specified IID and trace name.

According to some embodiments of the invention, the method further includes generating a new trace from a sequence of executed branches and entering the new trace into the trace database.

According to some embodiments of the invention, the new trace enters a trace history used for the trace prediction.

According to some embodiments of the invention, when the trace database stores a single trace for an IID, a trace is predicted based on history data of the IID.

According to an aspect of some embodiments of the present invention there is provided a method performed in a processor that executes instructions of program code, the method including:

monitoring sequences of instructions processed in the program code;

associating a respective invocation instruction identifier (IID) with each program code instruction which begins at least one trace;

specifying a single IID for trace prediction; and

predicting a trace based on a history of the single specified IID.

According to some embodiments of the invention, each trace is specified as a sequence of branch decisions.

According to some embodiments of the invention, each trace is specified by an IID and sequence of branch decisions.

According to some embodiments of the invention, the predicted trace is one of an immediately preceding predicted trace and a most frequently predicted trace of the single specified IID.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram illustrating three possible traces in a sequence of code instructions;

FIG. 2 is a simplified flowchart of a method of trace prediction, according to embodiments of the invention;

FIG. 3 is a simplified block diagram of a trace predictor according to embodiments of the invention;

FIG. 4 is a simplified diagram illustrating traces in a sequence of code instructions;

FIG. 5 is a simplified block diagram of a trace predictor according to embodiments of the invention; and

FIGS. 6 and 7 are simplified block diagrams of predictors, according to respective embodiments of the invention.

### DESCRIPTION OF SPECIFIC EMBODIMENTS OF THE INVENTION

The present invention, in some embodiments thereof, relates to parallel processing of code instructions and, more particularly, but not exclusively, to trace prediction during parallel processing.

Embodiments described herein use both trace prediction and branch prediction to generate predictions which are used to process code instructions according to a predicted sequence. Typically, the predictions are made by trace prediction based on a trace history. However when a branch misprediction is detected (or there are no traces associated with this point in the code) for a branch within the trace, trace prediction is suspended and subsequent predictions are made by branch prediction. The branch predictor makes branch predictions based on a branch history. Other types of predictors may additionally be used.

As used herein, the term “trace” means a sequence of branch decisions. The number of branch decisions within a trace may vary between one trace and another. Multiple traces may begin at the same point in the code instructions but the different sets of branches will contain a different sequence of code instructions.

As used herein the terms “invocation instruction identifier” and “IID” mean an identifier that indicates the point in the code instructions at which one or more traces begin.

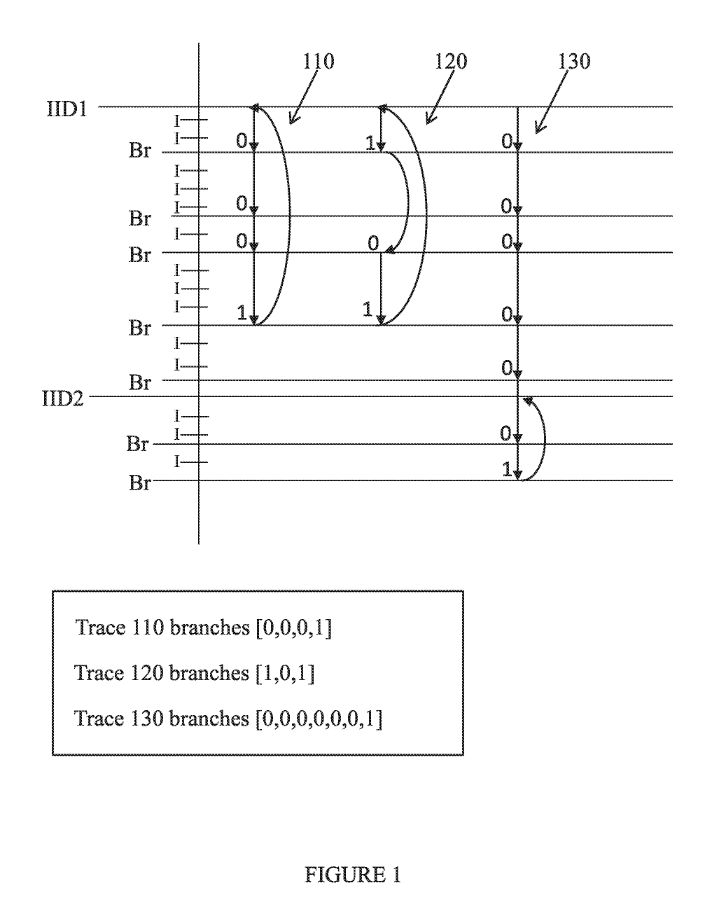

For the purposes of illustration, reference is now made to FIG. 1, which is a simplified diagram showing three traces which belong to code instruction IID1. “Br” indicates a branch code instruction, which may be taken or not taken. When the branch is not taken, processing proceeds sequentially. When the branch is taken, the processing jumps to a different code instruction (i.e. not to the next code instruction in sequence). “0” indicates that the branch is not taken. “1” indicates that the branch was taken. “I” indicates a code instruction which is not a branch, so that processing continues sequentially.

Trace 110 illustrates the processing sequence when branches following IID are [0,0,0,1] (i.e. not taken, not taken, not taken, taken). Trace 120 illustrates the processing sequence when branches following IID are [1,0,1]. It is seen that both trace 110 and trace 120 loop back to IID1. Trace 130 illustrates the processing sequence when branches following IID are [0,0,0,0,0,0,1]. Trace 130 terminates at IID2.

It is noted that when a branch is taken, the code instruction that is jumped to is not necessarily a branch code instruction (e.g. Br) but may also be a sequential code instruction (e.g. I).

It will be appreciated that a trace may be represented in many different manners. It is noted that the manner in which traces are represented is non-limiting to the scope of the embodiments of the invention; other representations of traces may be used.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

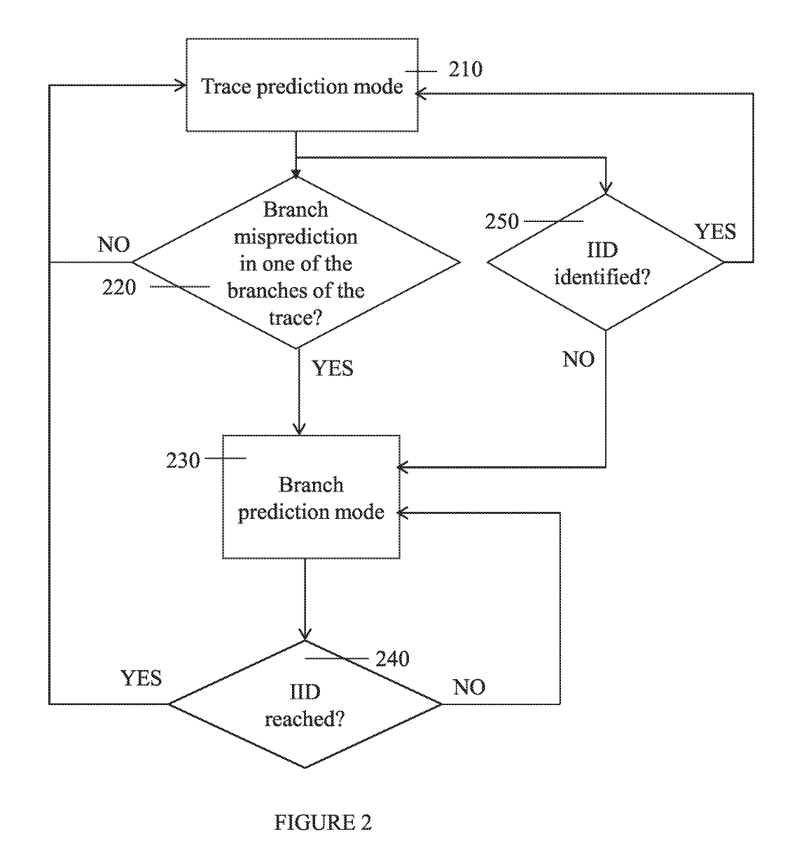

Reference is now made to FIG. 2, which is a simplified flowchart of a method of trace prediction, according to embodiments of the invention. The method combines trace and branch prediction, for a processor executing instructions of program code, to generate the predictions used during parallel processing. Optionally, the processor includes a non-volatile memory for storing the instructions of program code.

In 210 trace prediction is used to generate a prediction of a next trace for processing. Trace prediction may be performed by any means known in the art, and is typically based on trace history data and optionally other data (such as confidence levels). The predicted trace specifies a sequence of branch decisions. Optionally, the next IID is also predicted based on the predicted sequence of branch decisions (e.g. from trace information, return stack buffer or indirect branch predictor).

Trace prediction mode continues until a branch misprediction is detected in 220.

In response to detecting the branch misprediction, the method switches to branch prediction mode in 230. Optionally, other actions are taken to recover from the branch misprediction, such as flushing all instructions in the processor that are younger than the mispredicted branch.

Optionally, in 240 branch prediction mode ends and trace prediction mode resumes when an IID is reached during processing.

Optionally, the method includes a second criterion for switching to branch prediction. In 250, if the next IID of the predicted trace is not identified the method switches to branch prediction in 230. That is, if a predicted trace ends at a code instruction for which there does not exist an IID (with associated traces) that may be predicted, the method switches to predicting branches one by one.

### I) Trace Prediction

Trace prediction may be performed by any means known in the art, including, but not limited to, those of the above-cited “Path-Based Next Trace Prediction,” publication.

In some embodiments, during trace prediction mode the next trace is predicted using a prediction table which is indexed by a trace history.

Optionally, respective confidence level for a trace and/or the trace prediction are maintained.

Further optionally the respective confidence level for a trace and/or the trace prediction are updated at one or more of:

i) When a trace is executed (e.g. all of its branches were executed or the last branch of the trace was executed);

ii) When a branch from the trace is executed and found to be mispredicted;

iii) When a trace is committed or partially committed;

iv) When a trace is identified after at least one branch prediction;

v) When a trace is executed after at least one branch prediction; and

vi) When a trace is committed after at least one branch prediction.

As described in more detail below, multiple types trace predictors may be used to generate trace predictions, one of which is selected and used as the current predicted trace. Optionally, when the trace predictors provide different trace predictions, only some (one or more) of the trace predictors update the confidence level and/or trace prediction when one of the above cases occurs.

Optionally, a trace is considered executed when all branches in the trace have been executed. Alternately, a trace is considered executed when the last branch of the trace is executed.

Optionally, a trace is considered committed when all branches in the trace have been committed. Alternately, a trace is considered committed when the last branch of the trace is committed.

Optionally, upon prediction, when no thread is available, a trace prediction is output into a first-in first-out buffer (FIFO) at least every cycle, even when a trace is not required. Typically, it takes a cycle to make a trace prediction. In some cases more than one trace is needed in a single cycle (e.g. for parallel processing of multiple threads). If at some point multiple traces are needed in a single cycle, the FIFO is able to provide a trace to multiple threads.

Optionally, the predictions in the FIFO are used as resources become available.

Optionally, the trace predictions are made on a trace by trace basis, not necessarily at a particular stage of execution/processing/etc. of a previous trace. The predicted sequences of traces may be stored in the FIFO and controlled accordingly to obtain the next trace when resources are available.

Optionally, multiple trace predictions are generated for respective hardware threads.

Optionally, multiple traces may be taken simultaneously out of the FIFO buffer.

### I) Trace History

In some embodiments, trace prediction is based on a trace history (e.g. the next trace is predicted using a prediction table which is indexed by a function of the trace history).

The trace history is based, at least in part, on previously-predicted traces. For example, the trace history may be a sequence of previously predicted-traces in a shift register, where the predicted traces are each compressed using a hash function. Although this may result in occasional false hits in the prediction table, proper selection of the hash function may reduce memory usage significantly.

Optionally, a trace history is generated from:

a) A sequence of previously-predicted traces and/or executed traces;

b) A compressed sequence of previously-predicted traces (for example by taking just the first two bits of the trace names from a sequence of previously-predicted traces);

c) A single previously-predicted trace for the IID (for example the most recent predicted trace for the IID or the most frequently predicted trace for the current IID). Note that the most recent predicted trace for the IID may not be the most recent predicted trace which may have been predicted for a different IID;

d) A combination of at least one previously-predicted trace and at least one branch predicted by branch prediction. Thus, if a branch misprediction was detected in a previous trace, the trace history may include branch predictions that were made after switching to branch mode; and

e) At least one previously-constructed trace and at least one branch predicted by branch prediction.

Optionally, the trace history is updated dynamically during processing. For example branch predictions may be formed into a trace (which is either new or already exists) this new trace is added to the trace history and used for the next prediction.

Some embodiments of the invention include multiple trace predictors, as described below. When the trace predictors provide different trace predictions, one of the trace predictions is selected according to specified logic or rules. In such embodiments, the respective trace history input into each trace predictor may be generated differently and/or processed differently by the respective trace predictor in order to generate a prediction.

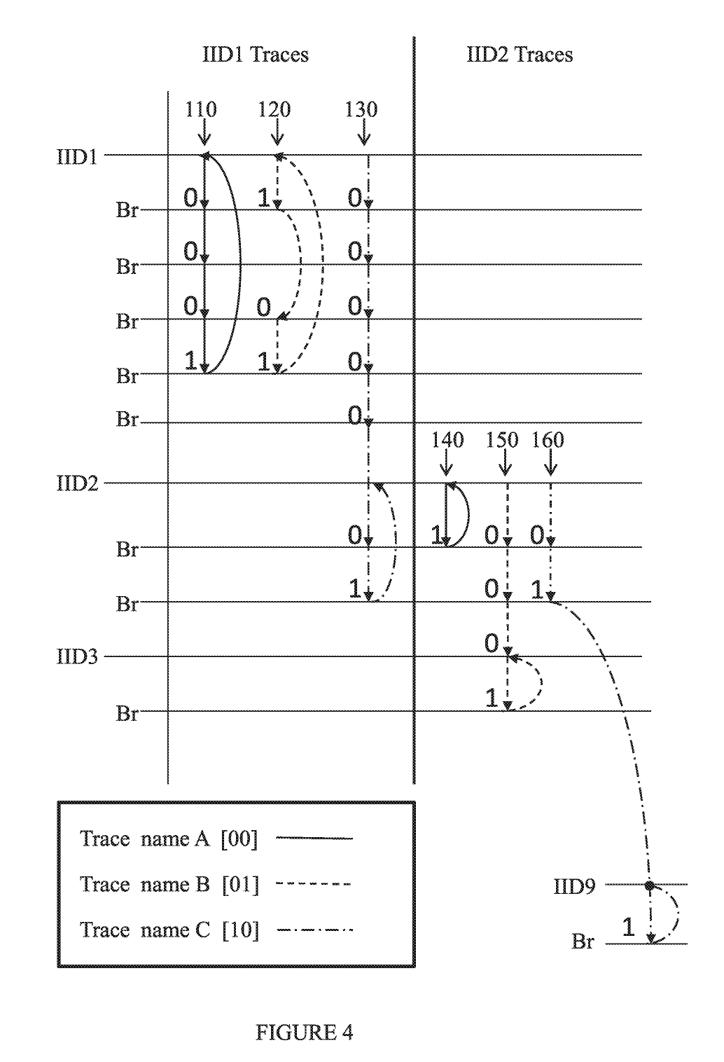

Optionally, the trace history is updated by shifting the data in the shift register by a number of bits smaller than the number bits of the trace name. (For example, in FIG. 4 below the length of the trace name is two bits so the data would be shifted one bit.) An exclusive OR (XOR) operation is performed for the lower bits of the shift register with the trace name. This enables holding more history in the history registers, while resulting in a limited amount of ambiguity in the trace history.

### II) Name-Based Trace Prediction

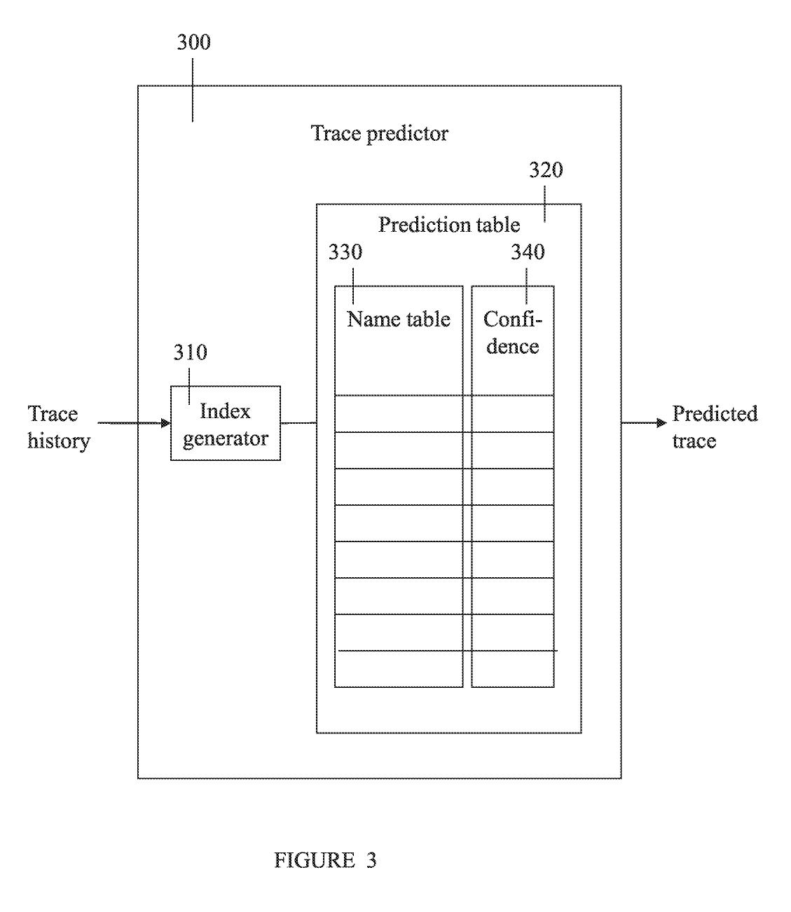

Reference is now made to FIG. 3, which is a simplified block diagram of a trace predictor according to embodiments of the invention. Trace predictor 300 uses a prediction table which does not store the entire trace (i.e. IID and sequence branch decisions). Instead the prediction table stores a trace name, which together with the IID represents the predicted trace. The prediction table is indexed by a function of the trace history.

It is noted that using a name-based trace predictor for trace prediction is not limited to the context of the embodiments illustrated by FIG. 2. The name-based trace predictor may be used as an independent trace predictor for other types of systems or devices which perform trace prediction, even if they do not switch between branch and trace prediction as described herein.

FIG. 4 illustrates the concept of a trace name. For clarity FIG. 4 shows only branch instructions; sequential instructions are not shown. As seen in FIG. 4, both IID1 and IID2 have a trace with trace name A (which is denoted [00] for both IID1 and IID2). However, for IID1 the sequence of branch decisions for trace name A is [0,0,0,1]; whereas for IID2 the sequence of branch decisions for trace name A is [1]. Thus, the name of the trace fully represents it only within the IID and various traces which belong to different IIDs may have the same name.

The trace database described below is used to determine the sequence of branch decisions for the current representation of a trace by IID+trace name.

Referring back to FIG. 3, index generator 310 processes the trace history and provides an index into name table 330 which stores the trace names. The index is used to retrieve the name of the predicted trace from name table 330. Trace predictor 300 outputs the predicted trace in the form of an IID+trace name.

Optionally, prediction table 320 maintains respective confidence levels 340 for traces stored in the prediction table (e.g. as a multiple-bit saturating counter). The confidence levels may be updated at several stages during prediction and processing.

### III) Trace Database

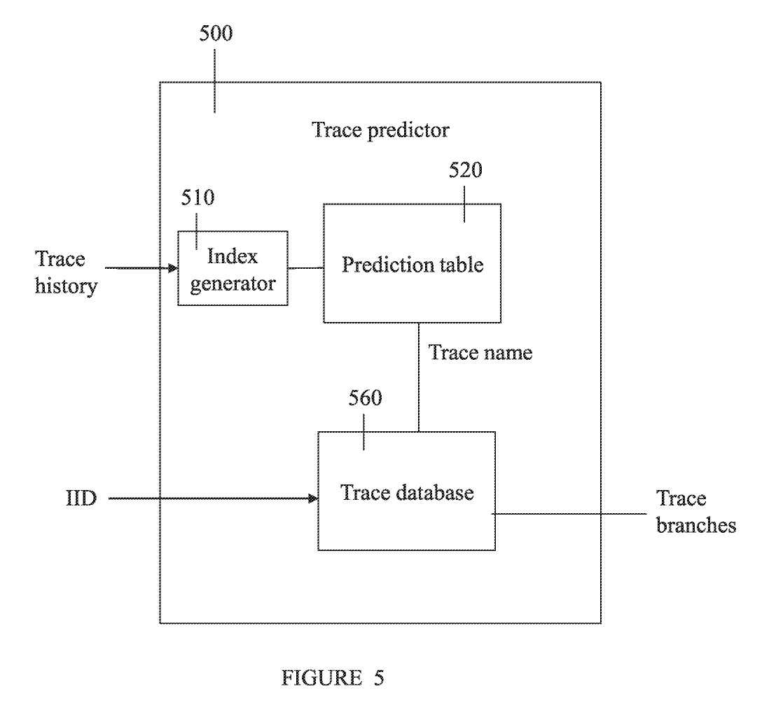

Reference is now made to FIG. 5, which is a simplified block diagram of a name-based trace predictor according to embodiments of the invention. In trace predictor 500, prediction table 520 outputs the predicted trace in the form of a trace name. In order to retrieve the branch decisions from a hierarchical trace database the IID is also needed.

Optionally, the IID used for the current prediction is included in the previous trace prediction (e.g. the Next IID field in the trace database as described below).

Optionally, prediction table 520 is structured similarly to prediction table 320 of FIG. 3.

The trace database stores complete traces (which explicitly specify branch decisions as taken or not taken) for respective combinations of IID and trace name.

Optionally, the trace database also stores the next IID which is arrived at when the trace is processed. For example, in FIG. 1 the next IID for traces 110 and 120 is IID1 and the next IID for trace 130 is IID2.

The trace database is used to determine the complete trace from the predicted IID+trace name. The IID and trace name are used to retrieve the sequence of branch decisions corresponding to the trace name from the trace database.

Table 1 shows an exemplary trace database corresponding to the traces illustrated in FIG. 4. When accessed using IID1 and trace name A, the sequence of branches retrieved from the trace database is [0,0,0,0,0,1]; whereas when accessed using IID2 and trace name A, the sequence of branches retrieved from the trace database is [1].

TABLE 1

| | | Trace branches | | |
|---|---|---|---|---|
| Current IID | Trace name | (0 = NT; 1 = T) | Next IID | Other data |
| IID1 | A [00] | 0, 0, 0, 1 | IID1 | |
| | B [01] | 1, 0, 1 | IID1 | |
| | C [10] | 0, 0, 0, 0, 0, 1 | IID2 | |
| | D [11] | — | — | |
| IID2 | A [00] | 1 | IID2 | |
| | B [01] | 0, 0, 1 | IID3 | |
| | C [10] | 0, 1, 1 | IID9 | |
| | D [11] | — | — | |
| IID3 | . | . | . | |
| | . | . | . | |
| | . | . | . | |

The trace database may not include all possible combinations of IID+trace name. Optionally, if the IID+trace name output by the trace predictor is not present in the trace database, a trace invalid prediction is detected and actions are taken to replace the invalid prediction. For example, when only three sequences of branches (named A, B and C) exist for IID1, the trace database does not include information for IID1+D. Thus if IID+D is predicted by the trace predictor, a trace invalid prediction is detected.

Optionally, when the trace database stores a single trace for an IID, trace prediction is performed based on history data of the IID not on trace history data as in other types of trace predictors (see, for example, the IID trace predictor described below).

Optionally, the trace database is built and maintained dynamically during processing. New trace names may be assigned to sequences of executed branches and/or predicted branches (e.g. obtained during branch prediction mode) and entered into the trace database. The name given to the sequence may be selected according to specified rules. For example, the sequence may be given a name which is not yet in use for its IID (e.g. for IID1 the selected name may be D). If all trace names have been used, the new sequence may be given a name currently in use and entered into the trace database to replace the previous set of branch decisions. Optionally, when a new trace is generated it enters the trace history used for trace prediction (e.g. it is used with index generation into a prediction table).

### IV) Branch Prediction

Optionally, branch prediction is based on a branch history which includes previously resolved branches.

Optionally, when a branch within a predicted trace is executed, the data used for branch prediction is updated. Further optionally, the data used for branch prediction is updated by transforming a trace history representation, up to the executed branch, into a branch history representation and using a function of the branch history representation for index generation to a branch predictor table.

During the trace prediction operation, the branch predictors may be updated for each branch. Assume, for example, that the trace predictor generated the following traces in the last 4 predictions: AABA. Further assume that A is made of 3 taken branches (1,1,1) and B is made of 3 not taken branches (0,0,0). Say now the second branch of B is executed and found to be mispredicted. Now, in order to update its prediction table, the branch predictor needs to generate the index to the table by transforming AA and the first branch of B to the following branch predicted history 1,1,1,1,1,1,0 (AA, first branch of B). Furthermore, it will now begin generating new branch predictions using the following branch history 1,1,1,1,1,1,0,1 (AA, first branch of B and corrected second branch of B).

Note that a function of this branch history is typically used to generate an index to the table. This function typically includes the use of the program counters of the branches and/or their target addresses.

For example, the branch predictor may maintain a confidence levels for branch predictions, and this confidence table may be updated when a branch is executed within a trace (i.e. no branch misprediction within the trace).

Furthermore, the branch prediction may be updated according to branch execution even during trace mode (i.e. when the branch predictor was not used for the prediction) and the history of the traces and branches may also be updated.

Optionally, during branch prediction the trace history, up to a mispredicted branch, is transformed into a branch history, and a function of the branch history is used to generate an index to the branch predictor table in order to produce branch predictions.

In some embodiments, portions of the code instructions are selected for branch prediction only. The portions of code may be selected based on structures in the code instructions (such as loops, functions and indirect branches).

Branch prediction may be performed by any means known in the art, including, but not limited to, gshare prediction, indirect branch prediction, return stack buffer (RSB), etc.

### V) IID Trace Predictor

In some embodiments of the invention, trace predictions are made with an IID trace predictor which outputs a trace prediction based on history data for a single specific IID. The predicted trace may be for the preceding trace of the single specific IID. Alternately, the predicted trace may be for a popular, frequently used trace of the IID.

It is noted that using an IID trace predictor for trace prediction is not limited to the context of the embodiments illustrated by FIG. 2. The IID trace predictor may be used as an independent trace predictor for other types of systems or devices which perform trace prediction, even if they do not switch between branch and trace prediction as described herein.

Optionally, when an IID predictor is used and there is only one known trace for an IID the trace is not entered into other trace predictor tables.

### VI) Overall Predictors

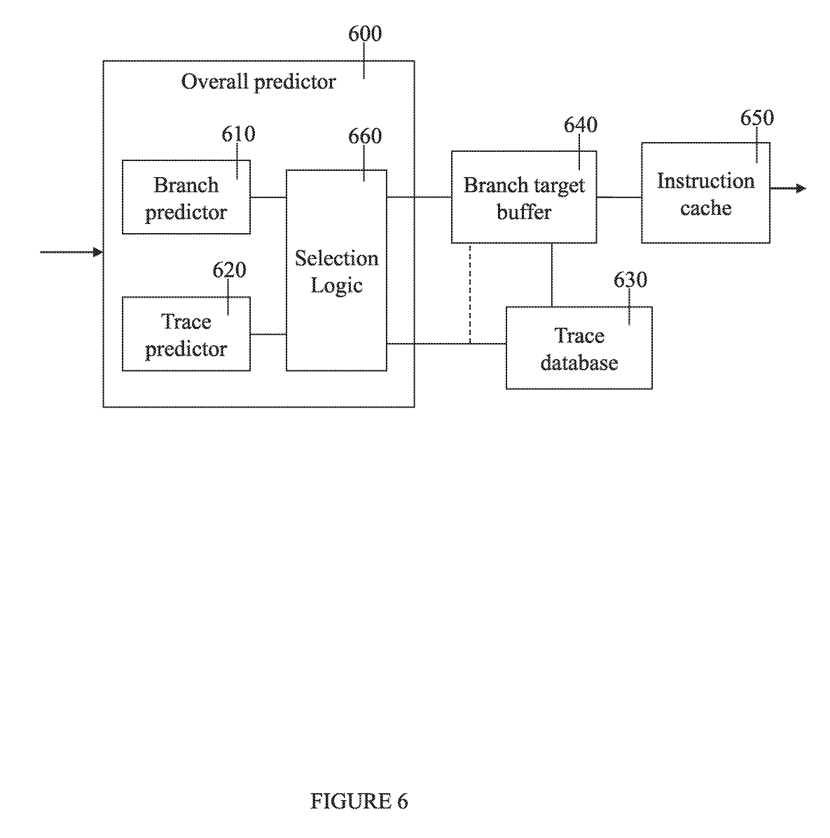

Reference is now made to FIG. 6, which is simplified block diagram of a predictor, according to embodiments of the invention. Predictor 600 includes branch predictor 610 and trace predictor 620. During trace mode, overall predictor 600 outputs the trace predictions from trace predictor 620. During branch mode (e.g. after misprediction of a branch within a trace), overall predictor 600 outputs the branch predictions from branch predictor 610.

Optionally, predictor 600 includes prediction selector 660 which selects which prediction (from branch predictor 610 or from trace predictor 620) is output as the final prediction.

Predictor 600 includes two prediction generators, branch predictor 610 and trace predictor 620. In other embodiments, the predictor includes additional prediction generators (as shown in the exemplary embodiment of FIG. 6). Optionally, one or more of these predictors may be inactivated as needed (e.g. for specified portions of the code). Deactivating predictors frees up computing resources, since fewer predictions are made simultaneously.

Optionally, trace predictor 620 uses a trace history based on multiple trace and/or branch predictions. Alternately, trace predictor 620 is an IID trace predictor which performs trace prediction based on a history data for a single IID (as described above).

Optionally, an IID trace predictor is used when a trace predicted based on trace history data is invalid.

Optionally, an IID trace predictor is used when there is a single trace for the current IID.

Optionally, an IID trace predictor is used when a logic unit decides that the trace predicted based on another trace predictor should not be used (e.g. the other trace predictors do not reach a majority agreement).

Optionally, when predictor 600 includes multiple trace predictors not all of the predictors update the trace database.

Optionally, predictor 600 outputs traces in the IID+trace name format, and trace database 630 is used to obtain the sequence of branch decisions.

Alternately or additionally, predictor 600 outputs the sequence of branch decisions directly and there is no need for a trace database.

Optionally, a branch target buffer (BTB) 640 and instruction cache 650 are used obtain the actual code instruction for processing. When branches are not taken, processing proceeds sequentially through the code instructions. When branches are taken, BTB 640 provides the target address for the taken branch. The target address is used to access instruction cache 650 to retrieve the actual code instruction. There is no need for a trace cache.

Optionally when a trace invalid prediction is detected or the sequence of branch predictions is otherwise unavailable a different type of prediction is used. Examples of different predictors which may be used include, but are not limited to:

i) A different type of trace predictor;

ii) A branch predictor; and

iii) An IID predictor which uses a single IID history to predict the next trace (as described in more detail above).

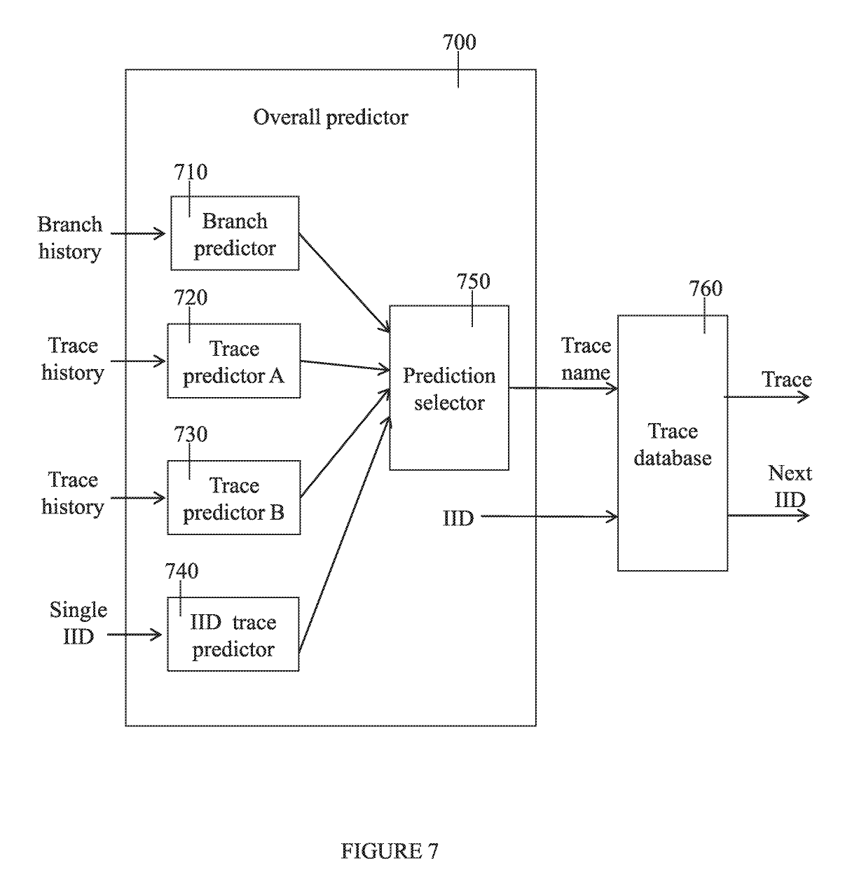

Reference is now made to FIG. 7, which is simplified block diagram of a predictor, according to exemplary embodiments of the invention. Predictor 700 includes four types of predictors: branch predictor 710, trace predictors 720 and 730, and IID predictor 740. Branch predictor 710 makes branch predictions by any means known in the art, typically based on a branch history. Trace predictors 720 and 730 are different types of trace predictors, each implemented by any means known in the art. Trace predictors 720 and 730 base the predictions, at least in part, on a trace history. Optionally, the trace history inputted into each of the trace predictors is generated in a different manner for each trace predictor. IID trace predictor 740 makes trace predictions based on history data for a single IID.

Optionally, each active predictor outputs a trace name, and prediction selector 750 selects which trace name will be provided to trace database 760 along with the IID. Trace database 760 outputs the complete trace.

It is expected that during the life of a patent maturing from this application many relevant traces, code instructions, trace predictors, branch predictors, databases, branch target buffers, instruction caches, pipelines and parallel processing techniques, will be developed and the scope of the term trace, instruction, trace predictor, branch predictor, database, branch target buffer, instruction cache, pipeline and parallel processing is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment.

Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method comprising:
in a processor that executes instructions of program code:
using trace prediction to predict a trace specifying a plurality of branch decisions, wherein each trace is associated with an invocation instruction identifier (IID) identifying a code instruction beginning said trace;
detecting a branch misprediction during processing of said predicted trace; and
in response to detecting a branch misprediction within a trace, terminating said trace prediction and continuing subsequent predictions using branch prediction.

2. A method according to claim 1, further comprising processing said predicted trace by:
for each taken branch in said trace, accessing a branch target buffer (BTB) to obtain a respective target address of a current branch; and
accessing an instruction cache with said target address to retrieve a code instruction.

3. A method according to claim 1, further comprising, when an IID is reached during branch prediction, resuming trace prediction to determine a continuing sequence of traces.

4. A method according to claim 1, further comprising: in response to detecting that a final code instruction at which a previous trace ends is unassociated with any traces, terminating said trace prediction and continuing subsequent predictions using branch prediction.

5. A method according to claim 1, wherein said using trace prediction comprises retrieving a predicted trace from a prediction table indexed by a function of a trace history.

6. A method according to claim 5, wherein said trace history consists of a plurality of previously-predicted traces and executed traces.

7. A method according to claim 5, wherein said trace history comprises at least one previously-constructed trace and at least one branch predicted by branch prediction.

8. A method according to claim 5, wherein said trace prediction table further comprises respective confidence levels for traces stored in said trace prediction table.

9. A method according to claim 1, further comprising when a trace is executed, updating a respective confidence level for said executed trace.

10. A method according to claim 1, further comprising when a branch from said trace is executed and found to be mispredicted, updating a respective confidence level for said trace.

11. A method according to claim 1, further comprising updating a trace history when a branch is predicted and a trace is formed.

12. A method according to claim 1, further comprising when a trace is committed, updating a respective confidence level for said committed trace.

13. A method according to claim 1, further comprising when a branch from said predicted trace is executed, updating at least one of a branch history and data used for said branch prediction.

14. A method according to claim 13, wherein said updating data used for branch prediction comprises: transforming a trace history representation, up to said executed branch, into a branch history representation, and using a function of said branch history for index generation to a branch predictor table.

15. A method according to claim 1, wherein said branch prediction comprises transforming a trace history, up to a mispredicted branch, into a branch history and using a function of said branch history for index generation to a branch predictor table in order to produce branch predictions.

16. A method according to claim 1, wherein said using trace prediction comprises:
maintaining a trace database storing, for combinations of an IID and a trace name, a respective sequence of branch predictions;
inputting an IID and trace name of a predicted trace; and
retrieving from said trace database, using said input IID and trace name, said respective sequence of branch predictions.

17. A method according to claim 16, wherein said trace database further stores, for combinations of an IID and a trace name, a respective next IID reached after processing said sequence of branch predictions, said method further comprising, retrieving from said trace database, using said input IID and trace name, a next IID reached after processing said sequence of branch decisions.

18. A method according to claim 16, when said sequence of branch predictions is unretrievable from said trace database, selecting a different type of prediction to continue said predicting.

19. A method according to claim 16, further comprising generating a new trace from at least one of executed branches and branches predicted by branch prediction, and entering said new trace into said trace database.

20. A method according to claim 19, wherein said new trace enters a trace history used for said trace prediction.

21. A method according to claim 16, wherein when said trace database stores a single trace for an IID a trace is predicted based on history data of said IID.

22. A method according to claim 1, further comprising, predicting a trace based on history data for a single IID.

23. A method according to claim 22, wherein said predicted trace is one of an immediately preceding predicted trace and a most frequently predicted trace of said single IID.

24. A method according to claim 1, wherein said using trace prediction to predict a trace comprises:
using a plurality of types of trace prediction to obtain respective predicted traces; and
selecting one of said predicted traces in accordance with specified logic.

25. A method according to claim 1, further comprising generating a plurality of trace predictions for respective hardware threads.

26. A method according to claim 1, further comprising outputting a trace prediction to a first-in first-out (FIFO) buffer each processor cycle and using said predictions in said FIFO as resources become available.

27. A predictor for parallelized processing of code instructions, comprising:
a processor configured to execute instructions of program code for:
during pipeline processing of code instructions, using trace prediction to predict a trace specifying a plurality of branch decisions, wherein each trace is associated with an invocation instruction identifier (IID) identifying a code instruction beginning said trace;
detecting a branch misprediction within said predicted trace; and
in response to said detecting, terminating said trace prediction and continuing subsequent predictions using branch prediction.

28. A predictor according to claim 27, further configured to execute code instructions for processing said predicted trace by:
for each taken branch in said trace, accessing a branch target buffer (BTB) to obtain a respective target address of a current branch; and
accessing an instruction cache with said target address to retrieve a code instruction.

29. A predictor according to claim 27, further configured to execute code instructions for:
resuming trace prediction when a trace IID is reached during said pipeline processing.

30. A predictor according to claim 27, further comprising at least one non-transient memory storing a trace database maintaining, for combinations of a invocation instruction identifier (IID) and a trace name, a respective sequence of branch decisions.

31. A predictor according to claim 27, wherein said using trace prediction comprises:
predicting a plurality of traces, each of said predictions being based on a respective trace history; and
selecting one of said plurality of predicted traces.

32. A predictor according to claim 27, wherein when a trace predicted based on a trace history comprising a plurality of previously-predicted traces is invalid, performing said trace prediction based on history data of a single IID.

33. A method comprising:
in a processor that executes instructions of program code:
monitoring sequences of instructions processed in said program code;
defining traces within said processed sequences of code, each trace being specified by a respective invocation instruction identifier (IID) identifying a code instruction beginning said trace and a sequence of branch decisions;
for each of said traces, assigning a trace name to said respective sequence of branch decisions and storing said trace names in a prediction table;
obtaining an index into said prediction table by applying a function to a specified history of traces; and
retrieving a trace name from said prediction table using said index.

34. A method according to claim 33, further comprising:
maintaining a trace database storing, for combinations of an IID and a trace name, a respective sequence of branch decisions; and
retrieving from said trace database, based on said retrieved trace name and a specific IID, said respective sequence of branch decisions.

35. A method according to claim 33, wherein said history of traces comprises a history of names of traces.

36. A method according to claim 34, for an IID, assigning an new set of branch decisions to a trace name and updating said trace database with said new set of branch decisions.

37. A method according to claim 34, wherein said trace database further stores, for combinations of an IID and a trace name, a respective next IID reached after processing said sequence of branch predictions, said method further comprising, retrieving from said trace database, using said IID and trace name, a next IID reached after processing said sequence of branch decisions.

38. A method according to claim 34, further comprising detecting an invalid trace when a sequence of branch predictions is unretrievable from said trace database for said specified IID and trace name.

39. A method according to claim 34, further comprising generating a new trace from a sequence of executed branches and entering said new trace into said trace database.

40. A method according to claim 39, wherein said new trace enters a trace history used for said trace prediction.

41. A method according to claim 34, wherein, when said trace database stores a single trace for an IID, a trace is predicted based on history data of said IID.

42. A method comprising:
in a processor that executes instructions of program code:
monitoring sequences of instructions processed in said program code;
associating a respective invocation instruction identifier (IID) with each program code instruction which begins at least one trace;
specifying a single IID for trace prediction; and
predicting a trace based on a history of said single specified IID.

43. A method according to claim 42, wherein each trace is specified as a sequence of branch decisions.

44. A method according to claim 42, wherein each trace is specified by an IID and sequence of branch decisions.

45. A method according to claim 42, wherein said predicted trace is one of an immediately preceding predicted trace and a most frequently predicted trace of said single specified IID.
